(19) United States
(12) Patent Application Publication
(10) Pub. No.: US 2023/0046733 A1
(43) Pub. Date: Feb. 16, 2023

(54) ACCESS CONTROL FOR A GAS CONTAINER

(71) Applicant: L'Air Liquide, Société Anonyme pour I'Etude et I'Exploitation des Procédés Georges Claude, Paris (FR)

(72) Inventors: Fangyan SUN, Versailles (FR); Jean-Patrice QUENEDY, Paris (FR)

(21) Appl. No.: 17/796,432

(22) PCT Filed: Jan. 11, 2021
(86) PCT No.: PCT/EP2021/050329

§ 371 Date: Jul. 29, 2022

(30) Foreign Application Priority Data
Jan. 29, 2020 (FR) FR2000869

(51) Int. Cl. G07C 9/00

(52) U.S. Cl. CPC G07C 9/00182; H04W 76/10

(57) ABSTRACT

An assembly having an access control device for a gas cylinder, a centralized management system, a gas cylinder and a mobile terminal the access control device having: an electrically controlled lock which is configured to allow the use of the cylinder when in the open position and to restrict the use of the cylinder when in the closed position, an identifier of the access control device comprising a printout or a radio tag, and a control unit configured to control the lock so as to open or close, a first, short-range, radio communication interface. Wherein the centralized management system has a computer configured to determine, on the basis of the identifier of the access control device, an access parameter for the first communication interface.

### CROSS REFERENCE TO RELATED APPLICATIONS

This application is a 371 of International Application No. PCT/EP2021/050329, filed Jan. 11, 2021, which claims priority to French Patent Application No. 2000869, filed Jan. 29, 2020, the entire contents of which are incorporated herein by reference.

### BACKGROUND

The present invention relates to an access control device for a gas cylinder and to an access control method for such a cylinder.

The document WO 2016/128472 discloses a device for providing a gas cylinder positioned in a free-access storage compartment, the device comprising motorized locking means.

In this type of device, a server determines the locker of the storage compartment which will be allocated to the customer, and therefore the locker which will be opened by the customer in order to make it possible to retrieve a cylinder. Consequently, the user cannot choose to take one cylinder in particular. In the same way, the user cannot choose the free locker in which they wish to put the empty cylinder which they bring back.

Such a mode of operation is not compatible with industrial use, making it difficult, for example, to handle batches of cylinders in spaces which are difficult to access.

This also limits the possibilities offered to the user, such as choosing a cylinder profile when several types coexist in the same environment.

### SUMMARY

The present invention aims to overcome these drawbacks effectively, by proposing an assembly comprising an access control device for a gas cylinder, a centralized management system, a gas cylinder and a mobile terminal, the access control device comprising:
an electrically controlled lock which makes it possible to allow the use of the cylinder when it is in the open position and to restrict the use of the cylinder when it is in the closed position,
an identifier of the access control device comprising a printout, or a radio tag,
a control unit configured to control the lock so as to open or close,
a first, notably short-range, radio communication interface,
   characterized in that the centralized management system comprises a computer configured to determine, on the basis of the identifier of the access control device, an access parameter for the first communication interface,

the mobile terminal comprising:
a second communication interface, configured to communicate with the centralized management system,
a third, notably short-range, radio communication interface, configured to communicate with the first communication interface,
an electronic circuit configured to sequentially:
   receive the identifier of the access control device,
   transmit the identifier of the access control device via the second interface,
   receive the access parameter, via the second interface,
   establish radio communication with the first communication interface, using the access parameter, in order to transmit, to the control unit, a control signal for controlling the lock so as to open or close.

The invention thus makes it possible, in the case of a room equipped with a plurality of cylinders, to leave it to the user to choose one cylinder in particular from among the plurality, for example when the user realizes that one of the cylinders seems faulty or suspect, or indeed to choose the free location to return a cylinder to. Thus, the invention allows greater flexibility in the management of a stock of cylinders, for example when the stock of cylinders changes by addition or removal, even of a small quantity of cylinders.

According to one embodiment, the radio tag comprises an RFD chip, notably an NFC chip.

According to one embodiment, the mobile terminal comprises a fourth, notably NFC, communication interface for reading the radio tag.

According to one embodiment, the identifier of the access control device is arranged to be able to be read freely by the mobile terminal.

Such a configuration makes it possible for the mobile terminal to read the identifier of the control device even though the mobile terminal is unaware of the access parameter.

According to one embodiment, the access control device is configured to activate the first communication interface only when it is in the closed position. This arrangement makes it possible to reduce the energy consumption which is necessary for the access control device.

According to one embodiment, the identifier of the access control device comprises printed electronics.

According to one embodiment, the identifier of the access control device comprises a detectable material such as a structured material or a permanent magnet.

According to one embodiment, the cylinder comprises a cylinder identifier which is secured to the cylinder, notably a printout, or a radio tag.

According to one embodiment, the cylinder identifier comprises printed electronics.

According to one embodiment, the cylinder identifier comprises a detectable material such as a structured material or a permanent magnet.

According to one embodiment, the first interface is configured to accept the establishment of communication only with a mobile terminal which has received the access parameter.

Such a configuration makes it possible to make access to the access control device secure.

According to one embodiment, the assembly comprises a fixing member arranged to be attached to the lock in the closed position and detached from the lock in the open position.

According to one embodiment, in the open position, the fixing member is free with respect to the lock.

Thus, the assembly makes it possible to access the cylinder in the open position and to restrict access to the cylinder in the closed position.

According to one embodiment, the fixing member and the lock are arranged in any one of the following configurations:
the fixing member is secured to a frame and the lock is secured to the cylinder, or
the fixing member is secured to the cylinder and the lock is secured to a frame, or
the fixing member and the lock are secured to a frame.

According to one embodiment, the fixing member comprises two free ends, the lock being mounted so as to be fixed with respect to one end, the other end being arranged to be connected to the lock in the closed position.

According to one embodiment, the lock is mounted so as to be fixed with respect to the cylinder and the fixing member comprises at least one portion arranged to be attached to the lock in the closed position.

According to one embodiment, the lock comprises a bolt mounted so as to be able to move, the movement of the bolt being electrically controlled in order to make it possible to move into the open position or into the closed position.

According to one embodiment, the lock comprises an electrically controlled valve.

According to one embodiment, the cylinder comprises a gas tank and a tap.

According to one embodiment, the valve is positioned upstream of the tap, for example between the gas tank and the tap, or downstream of the tap.

According to one embodiment, the valve is integrated into the tap.

According to one embodiment, the lock comprises a device for locking/unlocking the tap, notably one which is electrically controlled.

According to one embodiment, the cylinder identifier and the identifier of the access device are combined, notably in order to encode the same information.

Such a configuration allows access control which is independent of the possible movement of the cylinders.

According to one embodiment, the control signal is distinct from the access parameter.

According to one embodiment, establishing radio communication with the first communication interface comprises a step of pairing the first interface and the third interface, pairing being allowed by the first interface only after checking the access parameter.

Thus, the mobile terminal can initiate communication with the access control device only if it has received the access parameter beforehand.

According to one embodiment, the control unit is configured to control the lock so as to open or close depending on the control signal.

The invention relates furthermore to an access control method for a gas cylinder, using an assembly as described previously, the method comprising the steps of:
reading the identifier of the access control device,
transmitting the identifier of the access control device to the centralized management system,
determining, on the basis of the identifier 6 of the access control device, an access parameter for the first communication interface,
transmitting the access parameter to the mobile terminal,
establishing radio communication between the mobile terminal and the access control device, using the access parameter,
controlling the lock so as to open or close.

According to one embodiment, the method comprises the steps of:
reading the cylinder identifier,
transmitting the cylinder identifier to the management system.

According to one embodiment, the method comprises the step of:
storing information relating to a state of closure of the lock in relation to the identifier of the access control device and to the cylinder identifier, in order to make it possible to pair the cylinder and the access control device.

According to one embodiment, the step of storing information relating to a state of closure of the lock in relation to the identifier of the access control device and to the cylinder identifier is carried out by the centralized management system.

According to one embodiment, the method comprises a step of geolocating the mobile terminal.

According to one embodiment, the method comprises a step of acknowledging the command to open or close the lock.

According to one embodiment, the method comprises a step of the centralized management system generating a single-use code.

According to one embodiment, the method comprises a step of transmitting the single-use code to the mobile terminal or to a second mobile terminal, notably via a service message, for example of SMS type.

According to one embodiment, the method comprises an authentication step prior to transmitting the access parameter, notably by means of a request to enter a verification code on the mobile terminal.

According to one embodiment, the method comprises a step of the mobile terminal transmitting the verification code to the centralized management system and a step of the centralized management system comparing the verification code with the single-use code.

According to one embodiment, the method comprises a step of timestamping the command to open or close the lock.

The invention finally relates to a method for managing a fleet of gas cylinders, using an assembly as described previously, the method comprising a step of generating an order to deliver full cylinders in order to replace a predetermined batch of cylinders.

According to one embodiment, the method comprises a step of making the new or used state of a cylinder known, concomitantly with the closure of the lock.

### BRIEF DESCRIPTION OF THE DRAWINGS

The invention will be understood better from reading the following description and from studying the accompanying figures. These figures are given only by way of illustration and do not in any way limit the invention.

FIG. 1 is a schematic depiction of an assembly according to the invention;

FIG. 2 is a schematic depiction of an access control device according to the invention;

FIG. 3 is a schematic depiction of an access control method according to the invention.

### DETAILED DESCRIPTION OF PREFERRED EMBODIMENTS

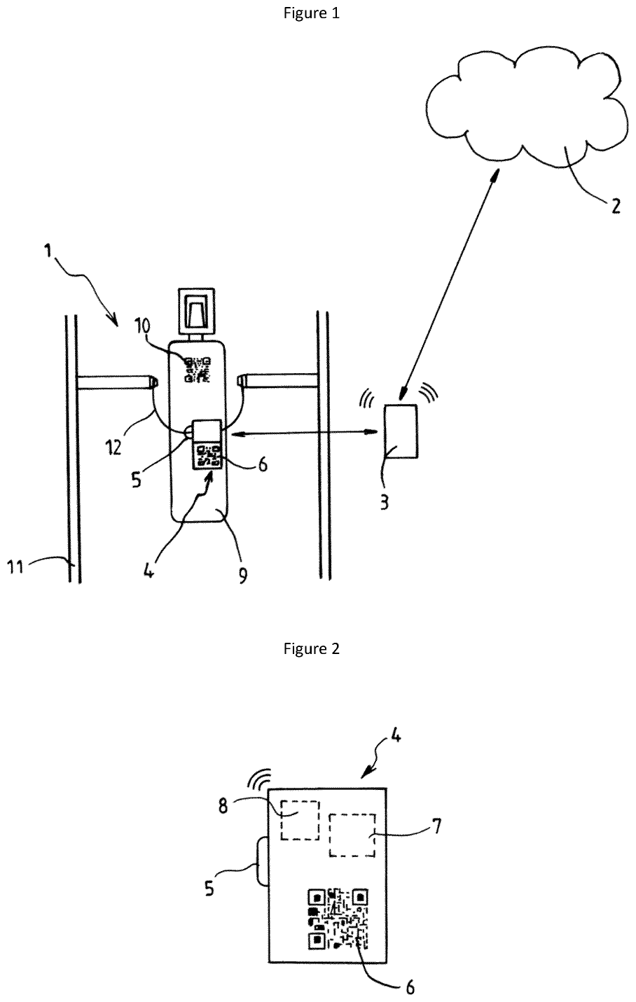

With reference to FIGS. 1 and 2, an assembly 1 comprising an access control device 4 for a gas cylinder 9, a centralized management system 2, a gas cylinder 9 and a mobile terminal 3 are depicted.

In the example under consideration, the access control device 4 comprises:
an electrically controlled lock 5 which makes it possible to allow the use of the cylinder 9 when it is in the open position and to restrict the use of the cylinder 9 when it is in the closed position,
an identifier 6 of the access control device comprising, in the example under consideration, a printout of barcode type, for example of QR code type,
a control unit 7 configured to control the lock 5 so as to open or close,
a first, notably short-range, radio communication interface 8, for example of Bluetooth, Bluetooth LE or NFC type.

The centralized management system 2 comprises a computer configured to determine, on the basis of the identifier 6 of the access control device, an access parameter for the first communication interface 8.

In the example under consideration, the access parameter may comprise the physical address of the Bluetooth or Bluetooth LE interface and/or an authentication password for this first interface 8. The centralized management system 2 comprises a data storage memory, in which a first table is stored which makes it possible to make a link between an identifier 6 of an access control device and the access parameter which is linked to it.

It remains possible to modify the access control parameter, for example for reasons linked to security.

In the example described, the mobile terminal 3 is a tablet or a mobile telephone. The mobile terminal 3 comprises:
a second communication interface, configured to communicate with the centralized management system 2, for example a Wi-Fi or cellular interface of 2G, 3G, 4G or 5G type,
a third; notably short-range, radio communication interface configured to communicate with the first communication interface 8, this third interface being in this instance of the same type as the first interface 8,
an electronic circuit configured to sequentially:
   receive the identifier 6 of the access control device,
   transmit the identifier 6 of the access control device via the second interface,
   receive the access parameter, via the second interface;
   establish radio communication with the first communication interface 8, using the access parameter, notably in order to transmit, to the control unit 7, a control signal for controlling the lock 5 so as to open or close.

In the example under consideration, the centralized management system 2 is a remote server.

The cylinder comprises a cylinder identifier 10 which is secured to the cylinder. In the example of FIG. 1, the cylinder identifier 10 takes the form of a barcode, for example a QR code or any other type of code which can be read by the mobile terminal 3.

The first interface 8 is configured to accept the establishment of communication only with a mobile terminal 3 which has received the access parameter beforehand. This makes it possible at the same time to make it easier to initiate detection of the correct communication interface, particularly when a plurality of cylinders 9 are stored in the same place. This furthermore makes it possible to ensure security of access to the first interface 8, so that only the mobile terminal 3 which has received the access parameter beforehand can actually establish communication and then exchange data with this first interface 8.

In the example of FIG. 1, the assembly 1 comprises a fixing member 12 arranged to be attached to the lock 5 in the closed position and detached from the lock 5 in the open position. In the open position, the fixing member 12 is free with respect to the lock 5. The fixing member 12 makes it possible to access the cylinder 9 in the open position and to restrict access to the cylinder 9 in the closed position.

In the example under consideration, the fixing member 12 and the lock 5 are secured to a frame. The frame can, for example, be a room, a depot or a container. The frame is not necessarily fixed with respect to the ground, but its possible movement is made difficult by its size and its weight, compared to the size and weight of a cylinder 9. In the example under consideration, the fixing member 12 comprises two free ends, the lock 5 being mounted so as to be fixed with respect to one end, the other end being arranged to be connected to the lock 5 in the closed position and free with respect to the lock 5 in the open position. In this case, the fixing member 12 is a chain welded to a metal beam 11 which is secured to the frame. A first end of the chain is connected to the lock 5 so that the lock 5 cannot be removed from this end. Another end of the chain can be inserted into the lock 5 when the latter is in the open position, so that the chain is connected to the lock 5 in the closed position.

The lock 5 comprises a bolt mounted so as to be able to move, the movement of the bolt being electrically controlled in order to make it possible to move into the open position or into the closed position. Thus, when the bolt moves so that the lock 5 moves into the closed position, it locks the other end of the chain.

In a variant not depicted in FIG. 1, the lock 5 comprises an electrically controlled valve. In the example under consideration, the valve is positioned between a gas tank of the cylinder 9 and a tap of the cylinder 9, in order to make it possible to control access to the gas of the cylinder 9. In this configuration, the cylinder can be moved even in the closed position, as access control is performed at the point of access to the fluid enclosed in the cylinder 9. The lock 5 can comprise both the electrically controlled valve and the movable bolt so as to make access control relating to both the movement of a cylinder 9 and its gas flow possible.

In a variant not depicted in FIG. 1, the lock 5 comprises a device for locking/unlocking the tap. This locking/unlocking device can comprise an electrically controlled pin. In the open position, the tap is operational and, in the closed position, the tap is inoperative.

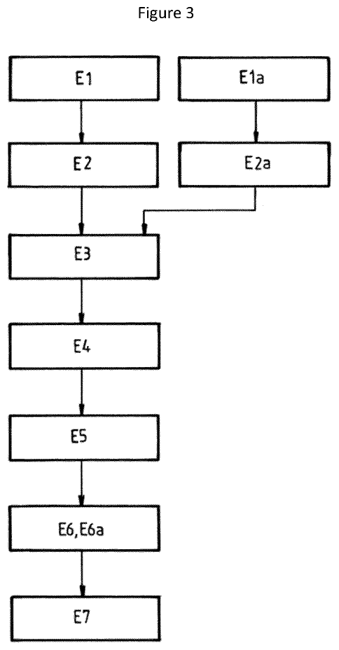

With reference to FIG. 3, an access control method for a gas cylinder 9 is depicted, using an assembly as described in FIGS. 1 and 2.

The method comprises the steps of:
reading E1 the identifier 6 of the access control device,
transmitting E2 the identifier 6 of the access control device to the centralized management system 2,
determining E3, on the basis of the identifier 6 of the access control device, an access parameter for the first communication interface 8,
transmitting E4 the access parameter to the mobile terminal 3,
establishing E5 radio communication between the mobile terminal 3 and the access control device 4, using the access parameter,
controlling the lock 5 so as to open E6 or close E6a.

The method can furthermore comprise the steps of:
reading Ela the cylinder identifier 10,
transmitting Eta the cylinder identifier 10 to the management system 2.

The method can furthermore comprise the step of:
storing E7 information relating to a state of closure of the lock 5 in relation to the identifier 6 of the access control device and to the cylinder identifier 10, in order to make it possible to pair the cylinder 9 and the access control device 4.

The step of storing E7 the information is performed by the centralized management system 2.

The storage memory of the centralized management system 2 is arranged to make it possible to store a second table for storing a pairing between an identifier 6 of an access control device and an identifier of a cylinder, when a cylinder 9 is locked by the lock 5 of an access control system 4.

The method can comprise a step of modifying the access parameter. In this case, the centralized management system 2 decides to modify the access parameter.

It transmits the old and the new value to the mobile terminal 3, which, when establishing communication with the first interface 8, begins by requesting the first interface 8 to change the access parameter in turn.

The method can comprise a step of acknowledging an operation:
of changing the access parameter, and/or
the lock 5 moving into the closed position, and/or
the lock 5 moving into the open position.

The acknowledgment step then consists in transmitting information between the access control device 4 and the centralized management system 2, via the mobile terminal 3, which acts as a gateway.

The method can comprise an authentication step prior to transmitting the access parameter. This authentication step can implement a step of generating a single-use code by means of an SMS message to a mobile telephone which is distinct from the mobile terminal 3, so as to reinforce the security of the access control method. In this case, the mobile terminal 3 displays a screen for entering a verification code and the user enters the code contained in the message as received by SMS. The method then comprises a step of the mobile terminal 3 transmitting the verification code to the centralized management system 2. The centralized management system 2 then comprises a step of comparing the verification code with the single-use code.

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

1.-10. (canceled)

11. An assembly comprising an access control device for a gas cylinder, a centralized management system, a gas cylinder and a mobile terminal the access control device comprising:
an electrically controlled lock which is configured to allow the use of the cylinder when in the open position and to restrict the use of the cylinder when in the closed position,
an identifier of the access control device comprising a printout or a radio tag,
a control unit configured to control the lock so as to open or close,
a first, short-range, radio communication interface,
wherein the centralized management system comprises a computer configured to determine, on the basis of the identifier of the access control device, an access parameter for the first communication interface,
the mobile terminal comprising:
a second communication interface configured to communicate with the centralized management system,
a third, short-range, radio communication interface, configured to communicate with the first communication interface,
an electronic circuit configured to sequentially:
receive the identifier of the access control device,
transmit the identifier of the access control device via the second interface,
receive the access parameter, via the second interface,
establish radio communication with the first communication interface, using the access parameter, in order to transmit, to the control unit, a control signal for controlling the lock so as to open or close.

12. The assembly as claimed in claim 11, establishing radio communication with the first communication interface comprising a step of pairing the first interface and the third interface, pairing being allowed by the first interface only after checking the access parameter.

13. The assembly as claimed in claim 11, further comprising a fixing member arranged to be attached to the lock in the closed position and detached from the lock in the open position.

14. The assembly as claimed in claim 13, the fixing member and the lock being arranged in any one of the following configurations:
the fixing member) is secured to a frame and the lock is secured to the cylinder, or
the fixing member is secured to the cylinder and the lock is secured to a frame, or
the fixing member and the lock are secured to a frame.

15. The assembly as claimed in claim 11, the lock comprising a bolt mounted so as to be able to move, the movement of the bolt being electrically controlled in order to allow movement into the open position or into the closed position.

16. The assembly as claimed in claim 11, the control signal being distinct from the access parameter.

17. An access control method for a gas cylinder, using an assembly as claimed in claim 11, the method comprising the steps of:
reading the identifier of the access control device,
transmitting the identifier of the access control device to the centralized management system,
determining, on the basis of the identifier of the access control device, an access parameter for the first communication interface,
transmitting the access parameter to the mobile terminal,
establishing radio communication between the mobile terminal and the access control device, using the access parameter,
controlling the lock so as to open or close.

18. The access control method as claimed in claim 17, further comprising the steps of:
reading the cylinder identifier,
transmitting the cylinder identifier to the management system.

19. The access control method as claimed in claim 18, further comprising the step of:
storing information relating to a state of closure of the lock in relation to the identifier of the access control device and to the cylinder identifier, in order to make it possible to pair the cylinder and the access control device.

20. A method for managing a fleet of gas cylinders, using an assembly as claimed in claim 11, the method comprising a step of generating an order to deliver full cylinders in order to replace a predetermined batch of cylinders.
